(19) United States
(12) Patent Application Publication
(10) Pub. No.: US 2013/0256926 A1
(43) Pub. Date: Oct. 3, 2013

(54) Method for Making Optical Sensor

(71) Applicant: Palle Geltzer Dinesen, Shenzhen (CN)

(72) Inventor: Palle Geltzer Dinesen, Shenzhen (CN)

(73) Assignees: AAC TECHNOLOGIES HOLDINGS INC., CAYMAN ISLANDS (GB); AAC ACOUSTIC TECHNOLOGIES (SHENZHEN) CO., LTD., Shenzhen (CN)

(21) Appl. No.: 13/542,656

(22) Filed: Jul. 5, 2012

(30) Foreign Application Priority Data
Mar. 30, 2012 (CN) 201210090854.4

(51) Int. Cl. B29D 11/00

(52) U.S. Cl. 264/1.7

(57) ABSTRACT

Disclosed are processes of method for making an optical sensor. The processes comprises the steps as follow: provide a carrier; mount an infrared ambient light detector, a proximity sensor and an infrared light emitter on the carrier; place a polymer layer on the carrier for fully coving the infrared ambient light detector, the proximity sensor and the infrared light emitter; provide a metal mold and press the polymer layer by metal mold for forming a first lens covering the infrared ambient light detector and the proximity sensor, a second lens coving the infrared light emitter, and a fixing concave positioned between the first and second lenses; insert and fix a light blocking element in the fixing concave for contributing to the minimization of crosstalk between the infrared ambient light detector and the infrared light emitter.

### FIELD OF THE INVENTION

The present invention generally relates to the arts of optical sensors, and particularly to a method for making an optical sensor with a proximity sensor unit and an ambient light sensor unit.

### DESCRIPTION OF RELATED ART

Optical sensors are known in the art and widely used in portable consumer devices. Generally, such a consumer device includes a proximity sensor and an ambient light sensor for detecting a distance between the device and an object, and detecting the ambient brightness of the environment. For meeting the trend of system integration, the proximity sensor and the ambient light sensor are designed to be one integrated module, i.e. the integrated module includes a proximity sensor unit combined with an ambient light sensor unit. Such an integrated module is called optical sensor in this application.

As disclosed in US Pub. No. 20110133941 A1, an optical sensor comprises a carrier, a shield forming a receiving room together with the carrier, a light detector, and a light emitter mounted on the carrier and received in the receiving room, respectively. The shield serves as a light blocking element to provide optical isolation between light emitter and light detector, so that undesired optical cross-talk between emitter and detector is minimized. However, the shield with a complicated shape and geometry is formed by metal stamping techniques, which makes the manufacture of the optical sensor difficult and expensive.

Therefore, it is desirable to provide an improved optical sensor which can overcome the above-mentioned problems.

### BRIEF DESCRIPTION OF THE DRAWINGS

FIG. 1 is an assembled view of an optical sensor in accordance with an exemplary embodiment of the present invention.

FIG. 2(a)˜2(g) shows steps of a method for making the optical sensor in FIG. 1.

Many aspects of the embodiment can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENT

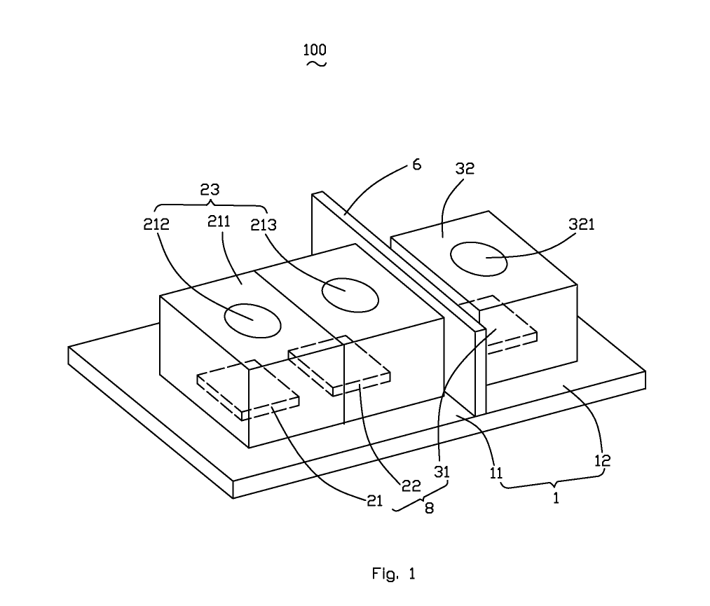

Reference will now be made to describe an exemplary embodiment of the present disclosure in detail. Referring to FIG. 1, an optical sensor 100 of the present disclosure comprises a carrier 1, a light blocking element 6 mounted on the carrier 1 for dividing the carrier 1 into a first side 11 and a second side 12, a light detecting portion mounted on the first side 11 of the carrier 1, and a light emitting portion mounted on the second side 12 of the carrier 1 and spaced apart from the light detecting portion. The light detecting portion comprises an infrared ambient light detector 21 mounted on or attached to the carrier 1, a proximity sensor 22 mounted on or attached to the carrier 1 and spaced apart from the infrared ambient light detector 21, and a first lens 23 covering the infrared ambient light detector 21 and the proximity sensor 22. The first lens 23 has a top portion 211, a first window 212 disposed through the top portion 211 and configured to be positioned directly over the infrared ambient light detector 21, and a second window 213 disposed through the top portion 211 and configured to be positioned directly over the proximity sensor 22. The light emitting portion comprises an infrared light emitter 31 mounted on or attached to the carrier 1 and a second lens 32 with a third window 321 disposed through a top surface of the second shield 32 and configured to be positioned directly over the infrared light emitter 31. The light blocking element 6 is used to minimize to occurrence of crosstalk between the infrared ambient light detector 21, the proximity sensor 22 and the infrared light emitter 31. The first and second lenses 23, 32 are formed from polymer. Combination of the infrared ambient light detector 21, the proximity sensor 22 and the infrared light emitter 31 is named an optical proximity sensor unit 8.

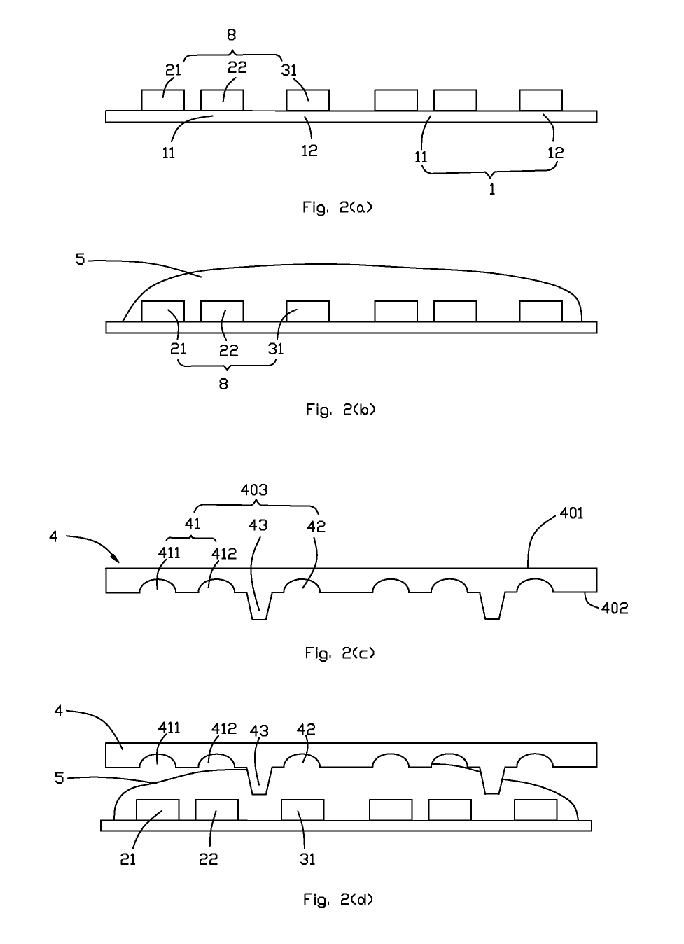

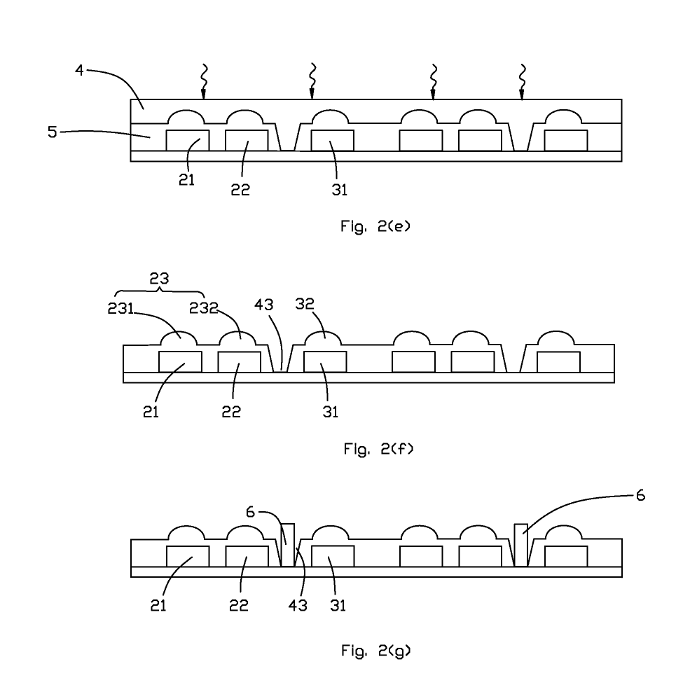

FIG. 2(a)˜2(g) illustrates processes of a method of making a plurality of said optical sensors 100. The processes comprise the steps as follows:

Step 1: referring to FIG. 2(a), provide a carrier 1 with a plurality of first sides 11 and a plurality of second sides 12 ; provide and mount a plurality of optical proximity sensor units on the carrier 1. The process of mounting each optical proximity sensor unit 8 on the carrier 1 comprises the steps of mounting the infrared ambient light detector 21 and the proximity sensor 22 on the first side 11 of the carrier 1, and of mounting the infrared light emitter 31 on the corresponding second side 12 of the carrier 1. The infrared ambient light detector 21, the proximity sensor 22 and the infrared ambient light detector 31 are spaced apart from each other.

Step 2: referring to FIG. 2(b), prepare and place a polymer layer 5 on the carrier 1 for fully covering the optical proximity sensor units 8;

Step 3: referring to FIG. 2(c), together with FIG. 2(d), provide a metal mold 4 having a first surface 401, a second surface 402 opposite to the first surface 401 and far away from the carrier 1, and a plurality of molding groups 403. Each of the molding group 403 has a first concave 41 extending form the first surface 401 towards the second surface 402 for forming lenses corresponding to the infrared ambient light detector 21 and the proximity sensor 22, a second concave 42 extending from the first surface 401 towards the second surface 402 for forming a lens corresponding to the infrared light emitter 31, and a projecting portion 43 projecting from the first surface 401 towards the carrier 1 and positioned between the first concave 41 and the second concave 42. Each first concave 41 includes a first concave portion 411 and a second concave portion 412 spaced apart from the first concave portion 411.

Step 4: referring to FIGS. 2(d) and 2(e), shape the polymer layer 5 by pressing the metal mold 4 down until the projecting portion 43 engages the carrier 1. During this step, thermal cure is applied.

Step 5: referring to 1(f), separate the metal mold 4 from the polymer layer 5 for forming a plurality of first lenses 23 covering the infrared ambient light detectors 21 and the proximity sensors 22, a plurality of second lenses 32 coving the infrared light emitters 31, and a plurality of fixing concaves 43 formed between the first and second lenses 23, 32. Each first lens 23 has a first lens portion 231 shaped by the first concave portion 411 for covering the infrared ambient light detector 21 and a second lens portion 232 shaped by the second concave portion 412 for covering the proximity sensor 22. The fixing concaves 43 are shaped by the projecting portions 43.

Step 6: referring to FIG. 2(g), insert and fix a plurality of light blocking elements 6 in the fixing concaves 43 for contributing to the minimization of crosstalk between the light emitting portion and the light detecting portion.

Step 7: divide the individual optical sensors by, for example, using sawing techniques well known to those skilled in the art.

The fixing concave is directly formed with the lenses, which makes the assembly process of fixing the light blocking element on the carrier much easier, so that the manufacture of the optical proximity sensor is simple and low-cost.

While the present disclosure has been described with reference to the specific embodiment, the description of the disclosure is illustrative and is not to be construed as limiting the disclosure. Various of modifications to the present disclosure can be made to the exemplary embodiment by those skilled in the art without departing from the true spirit and scope of the disclosure as defined by the appended claims.

What is claimed is:

1. A method of making an optical sensor, comprising the steps of:
providing a carrier;
mounting an infrared ambient light detector on the carrier;
mounting a proximity sensor on the carrier and spaced apart from the infrared ambient light detector;
mounting an infrared light emitter on the carrier and spaced apart from the proximity sensor;
placing a polymer layer on the carrier for fully coving the infrared ambient light detector, the proximity sensor and the infrared light emitter;
providing a metal mold having a first concave, a second concave spaced apart from the first concave, and a projecting portion projecting toward the carrier, the projecting portion being positioned between the first concave and the second concave;
shaping the polymer layer by pressing the metal mold down until the projecting portion engaging the carrier, the infrared ambient light detector and the proximity sensor locating on the same side of the projecting portion, and the infrared light emitter locating on the other side of the projecting portion;
assembling the polymer layer with the metal mold by thermal curing;
separating the metal mold from the polymer layer for forming a first lens covering the infrared ambient light detector and the proximity sensor, a second lens coving the infrared light emitter, and a fixing concave positioned between the first and second lenses; and
inserting and fixing a light blocking element in the fixing concave for contributing to the minimization of crosstalk between the infrared ambient light detector and the infrared light emitter.

2. The method of claim 1, wherein the first concave has a first concave portion for forming a first lens portion covering the infrared ambient light detector and a second concave portion spaced apart from the first concave portion for forming a second lens portion covering the proximity sensor.

3. The method of claim 1, wherein a plurality of optical sensors are formed on the carrier simultaneously.

4. The method of claim 1 further comprising the step of dividing the plurality of optical sensors by sawing.
